(19) United States
(12) Patent Application Publication
(10) Pub. No.: US 2026/0225571 A1
(43) Pub. Date: Aug. 6, 2026

(54) ELECTRIC PARK BRAKE ACTUATOR APPARATUS

(71) Applicant: Orscheln Products L.L.C., Moberly, MO (US)

(72) Inventors: Larry Brian CHAMP, Cairo, MO (US); Keith Raybon WEBB, Columbia, MO (US); Matthew Udeal MIDDENDORF, Hartsburg, MO (US); Joel Edward TAYON, Moberly, MO (US); Jacob Daniel LAPKA, Columbia, MO (US); Jae Mann YEH, Columbia, MO (US); Clinton James GUENTHER, Washington, MO (US)

(73) Assignee: Orscheln Products L.L.C., Moberly, MO (US)

(21) Appl. No.: 19/466,682

(22) Filed: Feb. 2, 2026

Related U.S. Application Data
(60) Provisional application No. 63/753,645, filed on Feb. 4, 2025.

(51) Int. Cl. B60T 13/74

(52) U.S. Cl. CPC B60T 13/746; B60T 2270/402; B60T 2270/406

(57) ABSTRACT

An electric park brake actuator apparatus is provided. In another aspect, a redundant electric park brake actuator apparatus includes multiple electromagnetic actuators, for example electric motors, which are configured to simultaneously or singly activate a vehicular brake cable. A further aspect of an electric park brake actuator apparatus is configured to sense both a travel distance and load of a parking brake cable. Yet another aspect includes electric motor actuators for pulling a parking brake cable, a programmable controller, redundant electrical circuits for each of the actuators, redundant power suppliers for each of the actuators, and at least one sensor, with the controller automatically determining if there is a malfunction preventing activation of one of the actuators, and if so, sending an output signal to a user warning device.

### CROSS-REFERENCE TO RELATED APPLICATION

The present application claims priority to provisional patent application Ser. No. 63/753,645, filed on Feb. 4, 2025, which is incorporated by reference herein.

### BACKGROUND AND SUMMARY

The present disclosure generally pertains to a park brake actuator and more particularly to a redundant electric park brake actuator apparatus.

Electric parking brake devices are known. For example, U.S. Pat. No. 6,386,338 entitled “Electric Parking Brake Manual Override,” issued to Powrozek on May 14, 2002, and U.S. Pat. No. 6,609,595 entitled “Electric Parking Brake with Direct Tension Feedback,” issued to Flynn, et al., on Aug. 26, 2003. These patents are incorporated by reference herein. It is notable that these conventional devices employ a single electric motor to pull a parking brake cable. However, if the single electric motor or its electrical circuit fails, then the parking brake will not be engaged.

Furthermore, commonly owned U.S. Pat. No. 6,406,102 entitled “Electrically Operated Parking Brake Control System,” issued to Arnold on Jun. 18, 2002. This patent teaches a control system which provides a driver with information regarding the status and potential problems with a parking brake-by-wire system. Also, commonly owned U.S. Pat. No. 5,180,038 entitled “Electronically Controlled Parking Brake System,” issued to Arnold, et al. on Jan. 19, 1993, discloses an optical sensor for counting the number of turns of a drive screw of a single DC motor, and a master controller controlling the DC motor and a solenoid for preventing double cycling that would otherwise damage a parking brake system. These patents are incorporated by reference herein. While these were significant improvements in the industry, further improvements and more sophisticated sensing within a parking brake actuator are desired.

In accordance with the present invention, an electric park brake actuator apparatus is provided. In another aspect, a redundant electric park brake actuator apparatus includes multiple electromagnetic actuators, for example electric motors, which are configured to simultaneously or singly activate a vehicular brake cable. A further aspect of an electric park brake actuator apparatus is configured to sense both a travel distance and load of a parking brake cable. Yet another aspect includes electric motor actuators for pulling a parking brake cable, a programmable controller, redundant electrical circuits for each of the actuators, redundant power supplies for each of the actuators, and at least one sensor, with the controller automatically determining if there is a malfunction preventing activation of one of the actuators, and if so, sending an output signal to a user warning device. A method of using an electric park brake actuator apparatus is also provided.

The present electric park brake actuator apparatus is advantageous over traditional devices since it provides cable actuation redundancy. The second electric motor actuator applies the brake even if there is a loss of one power supply or if there is a failure of the first electric motor or its electrical circuitry. There are redundant actuator and electrical circuitry systems to improve brake activation reliability and detection of faults. Additional advantages and features of the present apparatus will become apparent from the following description and appended figures.

### BRIEF DESCRIPTION OF THE DRAWINGS

FIG. 1 is a perspective view showing the present electric park brake actuator apparatus;

FIG. 2 is a perspective view showing a first embodiment of an actuator assembly of the present electric park brake actuator apparatus;

FIG. 3 is a fragmentary, perspective view, taken along line 3-3 from FIG. 2, showing the first embodiment of the present actuator assembly;

FIG. 4 is a top elevation view showing the first embodiment of the present actuator assembly, with a housing cover removed, in a cable-retracted and additional cable travel compensation position;

FIG. 5 is an exploded, perspective view showing the first embodiment of the present actuator assembly;

FIG. 6 is a cross-sectional view, taken along line 6-6 from FIG. 4, showing the first embodiment of the present actuator assembly, in a cable-releasing position;

FIG. 7 is a cross-sectional view, similar to that taken along line 6-6 from FIG. 4, showing the first embodiment of the present actuator assembly, in a position where the cable has traveled but full load has not been achieved;

FIG. 8 is a cross-sectional view, similar to that taken along line 6-6 from FIG. 4, showing the first embodiment of the present actuator assembly, in a cable-retracted and additional cable travel compensation position;

FIG. 9 is an electrical block diagram of the first embodiment of the present actuator assembly;

FIG. 10 is a software logic flow diagram for the first embodiment of the present actuator assembly;

FIG. 11 is a top elevation view showing a second embodiment of the present actuator assembly;

FIG. 12 is a cross-sectional view, taken along line 12-12 from FIG. 11, showing the second embodiment of the present actuator assembly;

FIG. 13 is a side elevation view showing the second embodiment of the present actuator assembly;

FIG. 14 is a cross-sectional view, taken along line 14-14 from FIG. 13, showing the second embodiment of the present actuator assembly;

FIG. 15 is a cross-sectional view, similar to that taken along line 14-14 from FIG. 13, showing the second embodiment of the present actuator assembly, in a cable-released position;

FIG. 16 is a cross-sectional view, similar to that taken along line 12-12 from FIG. 11, showing the second embodiment of the present actuator assembly, in a cable-released position;

FIG. 17 is a cross-sectional view, taken along line 14-14 from FIG. 13, showing the second embodiment of the present actuator assembly, in a cable-retracted and additional cable travel compensation position;

FIG. 18 is a cross-sectional view, similar to that taken along line 12-12 from FIG. 11, showing the second embodiment of the present actuator assembly, in a cable-retracted and additional cable travel compensation position;

FIG. 19 is a perspective view showing the second embodiment of the present actuator assembly, with a housing lid and gear case removed;

FIG. 20 is a cross-sectional view, similar to that taken along line 14-14 from FIG. 13, showing the second embodiment of the present actuator assembly;

FIG. 21 is a fragmentary and enlarged perspective view showing the second embodiment of the present actuator assembly, with the housing lid and gear case removed;

FIG. 22 is an electrical circuit diagram of the second embodiment of the present actuator assembly; and

FIG. 23 is an electrical circuit diagram of the second embodiment of the present actuator assembly.

### DETAILED DESCRIPTION

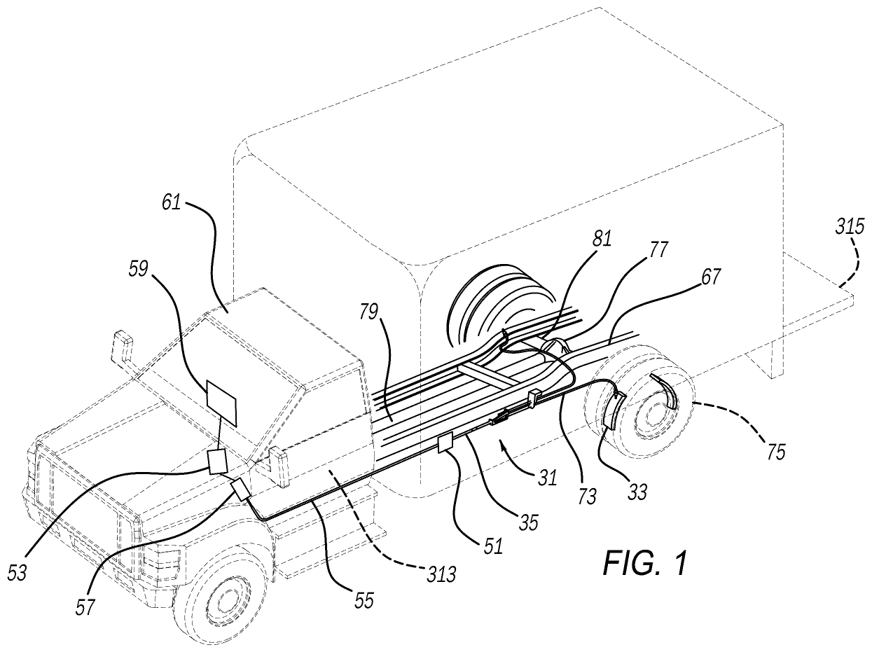

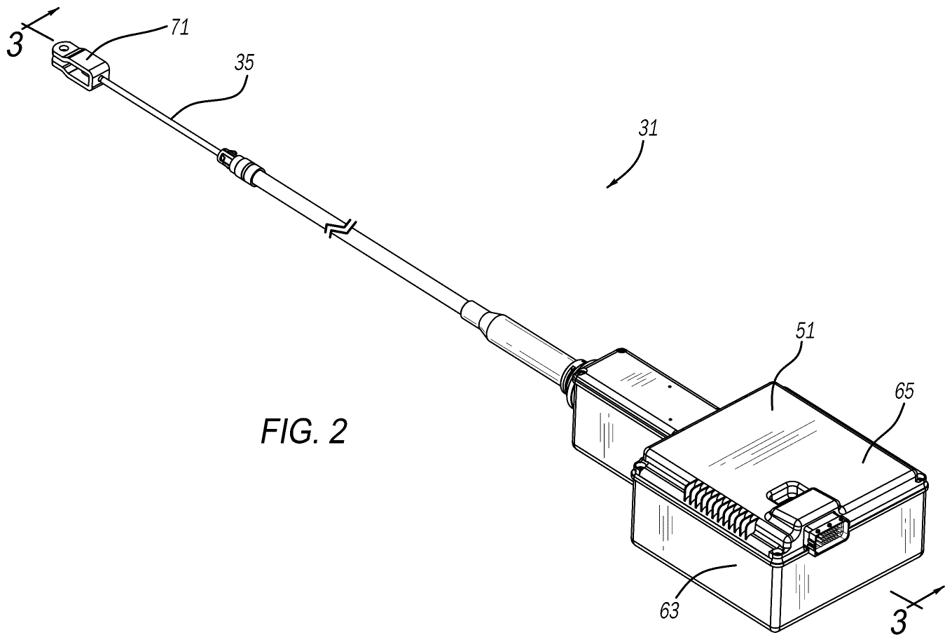

Referring to FIGS. 1 and 2, a preferred embodiment of an electric park brake actuator apparatus 31 includes a vehicular parking brake 33, an elongated and flexible cable 35 connected to the parking brake, an actuator assembly 51 and multiple battery power supplies, such as batteries 53. Electrical circuits 55 are connected to batteries 53 and include a user-activated electrical switch 57 and an output display screen 59 or warning light, located within a cab of an automotive vehicle 61. Actuator assembly 51 includes an exterior housing, with a housing body 63 and a housing cover 65, coupled thereto by fasteners. The housing has holes for receiving threaded fasteners, to allow its mounting to a structural inside frame rail 67 or the like, of automotive vehicle 61 such as a commercial cargo truck, passenger bus or the like. Cable 35 has a clevis fastener 71 at a distal end thereof which couples to a single or branched pair of elongated and flexible, parking brake secondary cables 73. A distal end of cable 73 is coupled to parking brake 33, which may be located adjacent to and/or in contact with a rotating wheel 75, differential 77, transmission 79 or axle 81.

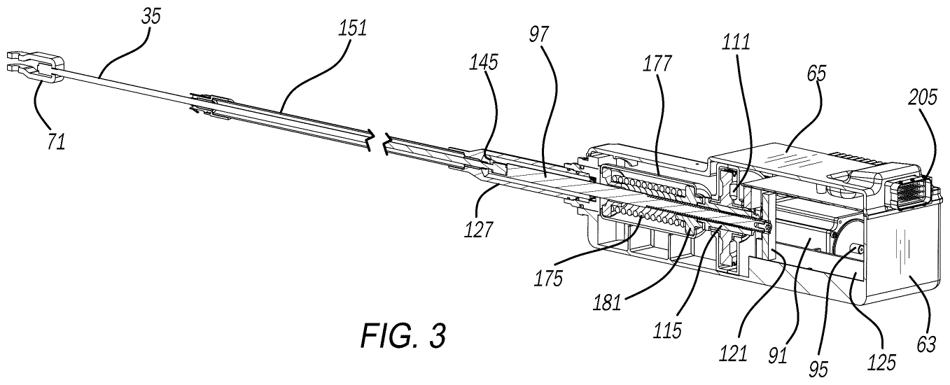

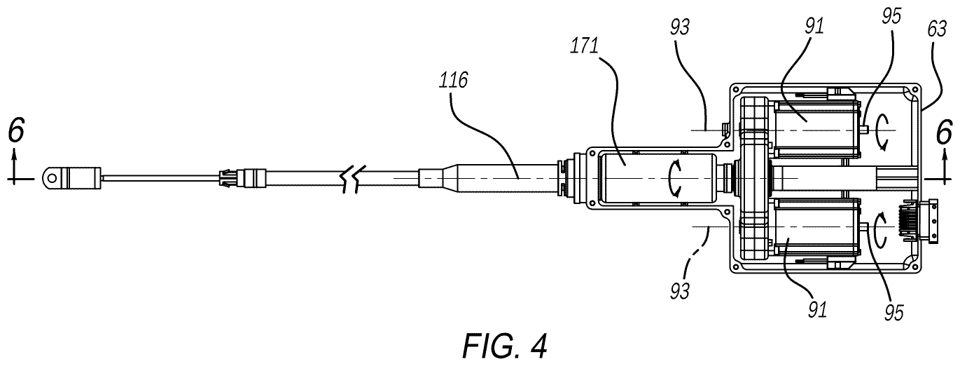

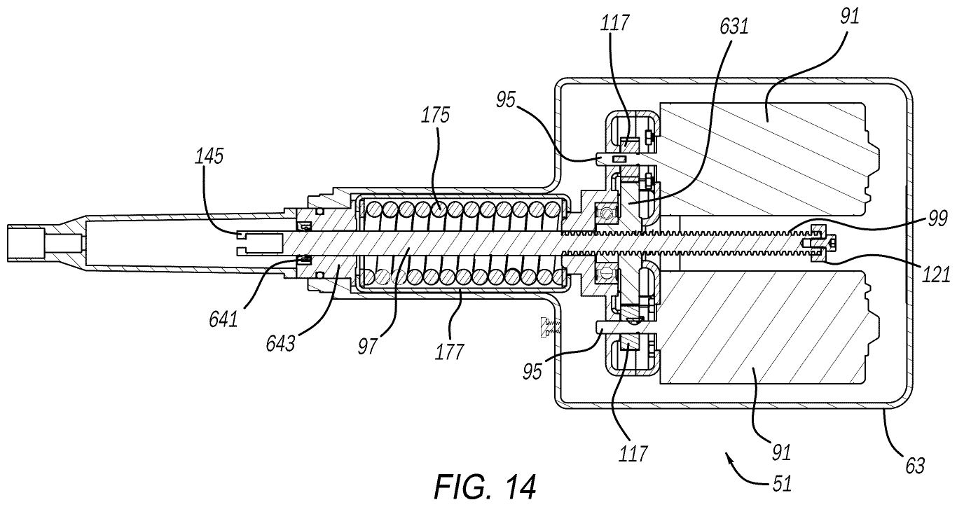

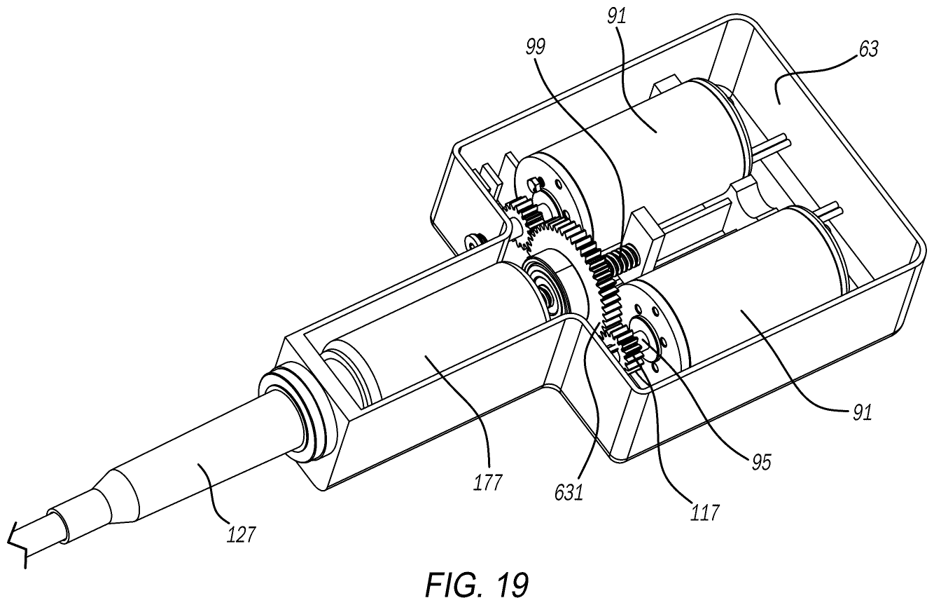

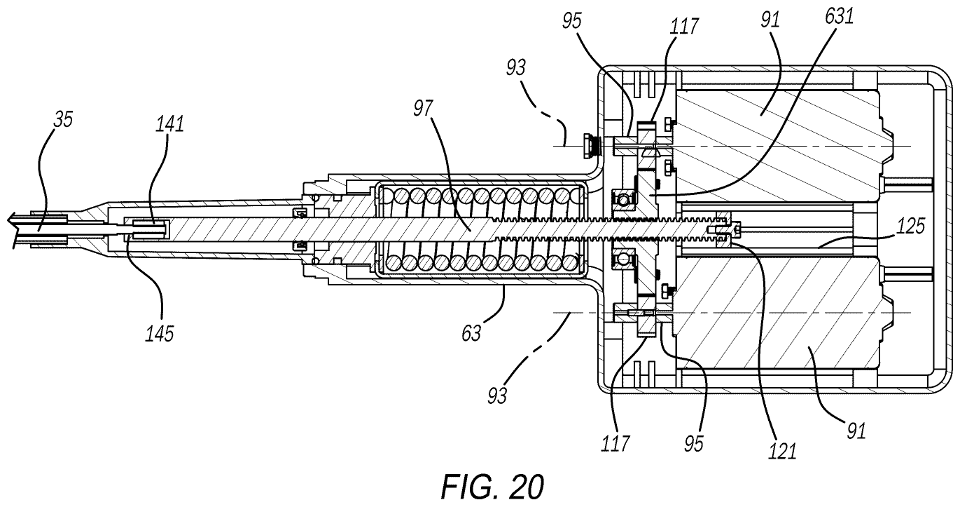

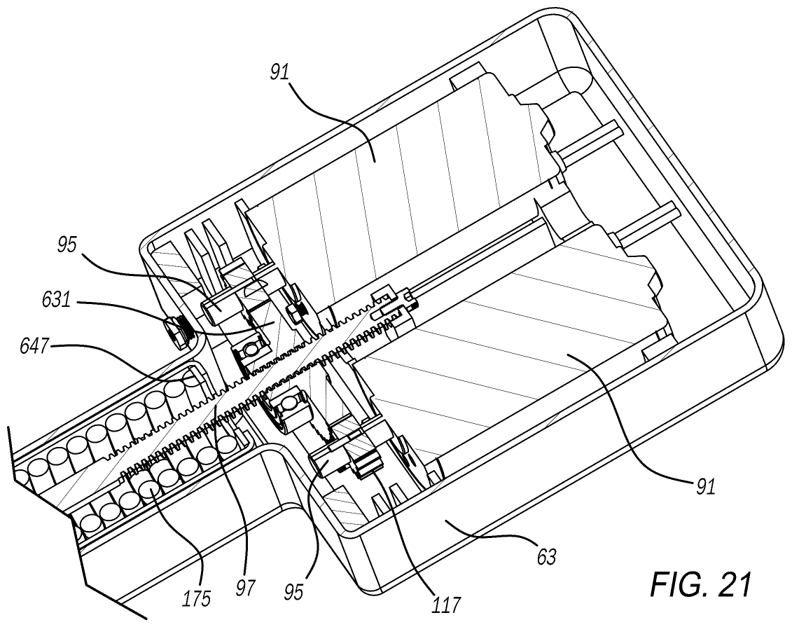

Referring now to the first embodiment of FIGS. 3-5 and the second embodiment of FIGS. 14, 16 and 19-21, actuator assembly 51 includes two electric motors 91 that are laterally offset from each other with rotational axes 93 of and their longitudinally elongated and central armatures 95 being substantially parallel to each other. The actuator assembly further includes a longitudinally elongated shaft 97 having an externally threaded drive screw portion 99 located between electric motors 91. Each motor 91 may include brushes or be brushless, however, it is preferred that the present motors be brushless as will be discussed in greater detail hereinafter. A manual motor disconnect may be optionally included to allow for free-spinning of the motors when the electrical power is disconnected.

FIGS. 3 and 5-7 show a gear set within the actuator assembly, which includes a drive gear 111 having spaced apart internal splines 113, which enmesh with spaced apart external splines 114 of a nut 115. The splines of the drive gear and the splines of the nut are linearly oriented parallel to a central rotational axis 116 of shaft 97, which allows nut 115 to linearly slide in the longitudinal direction parallel to axis 116 (which is also parallel to motor axes 93), while it is rotated about its central axis 116 by drive gear 111. In other words, rotational axes of the first electric motor and of the second electric motor are parallel to each other, and parallel to a longitudinal centerline of the shaft. Nut 115 further has internal teeth enmeshed with drive screw portion 99 of jackscrew shaft 97.

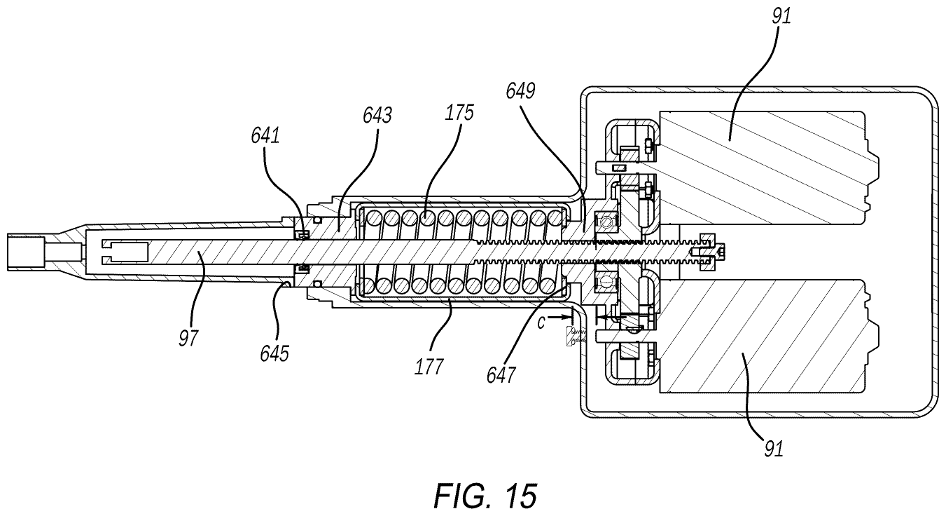

The gear set also includes an output pinion gear 117, operably rotated by each motor armature 95 about axis 93, which serves to rotate drive gear 111. In other words, external teeth of both pinion gears 117 are enmeshed with drive gear 111, such that both motors simultaneously rotate at the same speed to rotate drive gear 111, nut 115 and shaft 97, when in a normal and fully functional operating condition. Conversely, if one of motors 91 ceases to operate (whether due to a problem with the motor, its electrical circuit or its power supply), then the other of the motors will actively rotate its pinion gear 117, drive gear 111, nut 115 and shaft 97, while the inoperable motor merely passively rotates. The substantially parallel motors, pinion gears and drive gear configuration, with a section of the jackscrew shaft being parallel to and between the motors, are arranged the same as those components of the second embodiment, which are illustrated in FIG. 15.

Returning to FIGS. 3-8, an anti-rotational alignment block 121 is attached adjacent a proximal end of shaft 97 via a fastener 123. A longitudinal guide track 125 affixed to or integrally projecting from a bottom of the housing body and/or cover deters alignment block 121, and indirectly shaft 97, from rotating with the drive gear. Thus, motor and gear rotation cause the shaft to linearly advance and retract toward and away from a longitudinally projecting end tube fitting 127, which extends from housing 63.

A laterally enlarged button or head 141 of cable 35 is removably received within a cavity behind undercut and inwardly turned flanges 145 at a distal end of shaft 97. Accordingly, the shaft attaches to the brake cable to pull the mechanical brake, when either or both of the motors are energized. A shaft seal 147 is located between an outer surface of shaft 97 where it enters through a hollow cap 149, and allows the shaft to slide therethrough. It is noteworthy that the connection of the cable to the shaft occurs external to the sealed housing body and cover. This beneficially allows removal and replacement of the cable without exposing the motors, gears and electronics to the normal dirty vehicle environment during repairs and maintenance. Furthermore, an elongated conduit 151 concentrically surrounds cable 35, with a proximal end attached within a distal open end of end tube fitting 127.

An accumulator assembly 171 is disposed inside a neck 173, longitudinally projecting from a laterally enlarged section of actuator assembly housing body 63. The accumulator assembly has a compression spring 175 located within a surrounding can 177. Such a spring and can are disclosed in commonly owned U.S. Pat. No. 6,935,626 entitled “Spring Assembly,” which issued to co-inventor Larry Champ on Aug. 30, 2005. This patent is incorporated by reference herein.

Spring 175 is helically coiled around an unthreaded portion of shaft 97 with a first end abutting against an annular stationary receiver 179, through which the shaft moves. Moreover, a longitudinally movable piston or plunger 181 engages with a second end of spring 175 such that the spring biases piston 181 toward an inwardly flanged end of can 177 and toward a lateral plane through drive gear 111.

A thrust bearing is preferably located between piston 181 and nut 115, so as to translate the linear motion and work to the piston without transferring rotational motion. Furthermore, bearings are also provided for the drive gear and nut relative to the stationary gear case and/or housing body. The gear case preferably contains a lubricant for the gears therein.

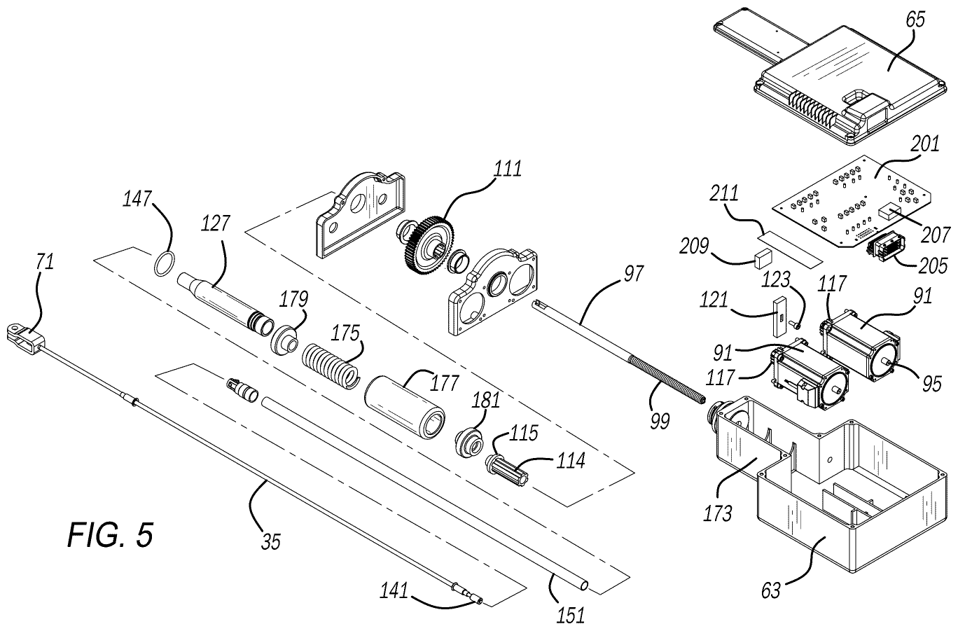

A printed circuit board 201 is mounted within the sealed housing body and cover, 63 and 65 respectively, and has electrical circuits 203 connected to an electrical connector 205, as can be observed in FIGS. 5, 6 and 9. Electrical connector 205 is removably connected to wires, which are in turn, connected two multiple battery power supplies, one associated with each motor 91, the user-activated switch and the output display. Electrical circuits 203 include microprocessors 207 (one for each motor), a load-achieved sensor 209, an elongated travel sensor 211, and RAM and/or ROM memory within which is stored programmable software in a non-transient manner. The longitudinal position of antirotational block 121, serves as a flag, which is sensed and detected by travel sensor 211.

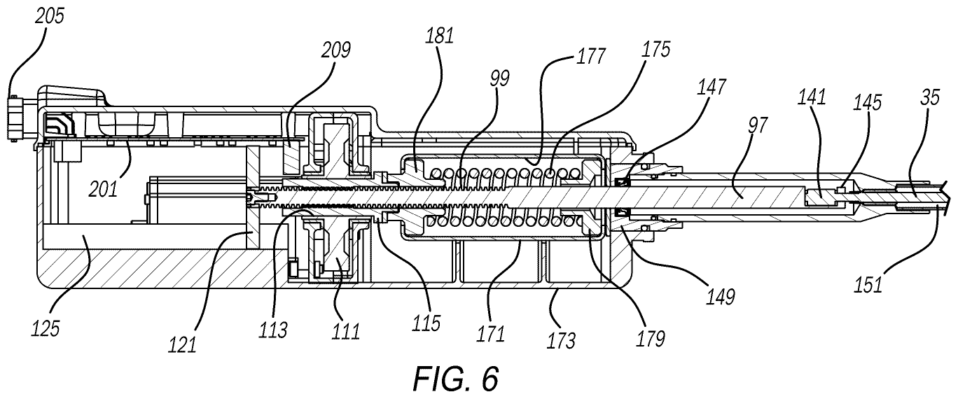

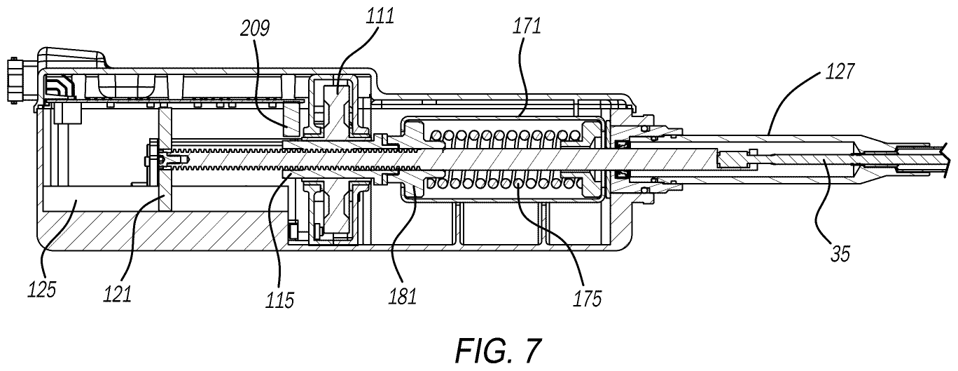

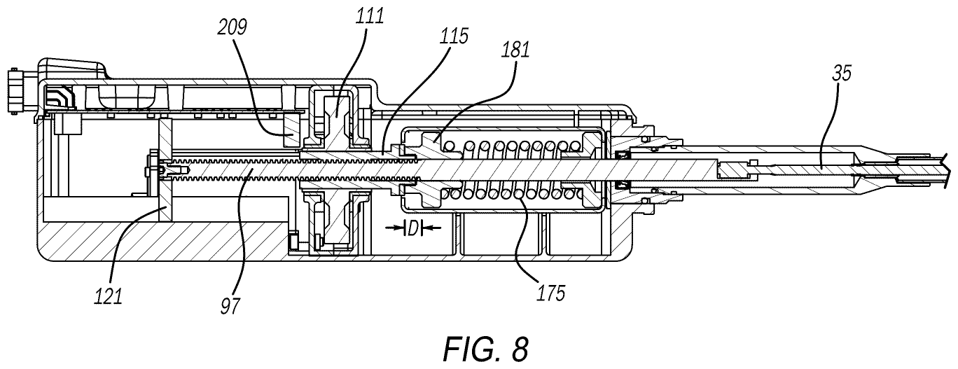

The sequence of operation is as follows:
(a) electric motors 91 first rotates main gear 111;
(b) main gear 111 rotates splined nut 115;
(c) initially, before the spring preload is exceeded, spline nut 115 longitudinally moves jackscrew shaft 97 to the left (as is illustrated by comparing FIGS. 6 and 7);
(d) next, after the spring preload is exceeded, further rotation of spline nut 115 causes the nut to slide to the right (as illustrated in FIG. 8) which pushes piston 181 to the right by distance ‘D,’ against compression spring 175, while jackscrew shaft 97 stays in generally the same retracted position;
(e) when travel sensor 209 senses rightward (as shown in FIG. 8) positioning of spline nut 115, it sends a signal to microprocessor 207, which then stops electric motors 91; the full rightward positioning of the splined nut indicates that the spring preload has been exceeded a desired amount; and
(f) the preload on spring 175 provides additional cable travel in cable 35 while the motors 91 remain stopped.

In other words, piston 181 cannot move until the cable load is greater than the preload in the spring 175. But when the cable load exceeds the spring preload, nut 115 and piston 181 will move away from the drive gear 111 as spring 175 compresses. Therefore, load-achieved sensor 209 automatically detects movement of the preloaded spring 175 via piston 181 and splined nut 115 positioning. This indirectly indicates that the actuator apparatus has achieved desired pulling load or force on parking brake cable 35. Approximately 3-10 mm of additional cable travel can be provided. Additional cable travel may be desired due to longitudinal expansion of the preloaded/pre-compressed spring 175, depending on the specific system dimensions within which the present apparatus is employed in feature is ideally suited to accommodate and overcome variations due to external factors while still maintaining the desired target pulling load on the cable. These variations include but are not limited to relaxing or deformation of the cable or parking brake components; relaxing or motion of cable mounting brackets; motion within the brake because the vehicle has changed from angling uphill to downhill or vice versa; and/or temperature-induced expansion or contraction of the cable or brake components.

Moreover, the present embodiment advantageously integrates the sensors into a single printed circuit board, within the sealed housing. The circuit board and all electrical components for the present actuator assembly are located on a single end of the housing, opposite an end containing the accumulator spring and brake cable, with a lateral plane through the drive gear separating these ends. This arrangement serves to condense the packaging size and place the sensors closer to the sensed moving parts and closer to the microprocessor controller.

Moreover, the thread pitch of the jackscrew shaft is selected with a low helix angle such that the friction of the thread will be enough to retain position of and present rotation of the nut, when the motors are deenergized, thereby maintaining cable-pulling load. In other words, when the motors stop, they do not need any electrical power or need to be shorted for the actuator to maintain load on the cable. This beneficially allows the parking brake to still be applied and hold load even when there is no electrical power being supplied to the motor actuators, such as if a battery fails or there are other electrical circuitry problems with the vehicle or actuator apparatus.

Each electromagnetic actuator is preferably a brushless direct current (“BLDC”) electric motor 91, which is controlled by electrical drive signals. These brushless motors advantageously provide large amounts of torque over a broad range of speeds. This is more reliable, more durable, of smaller size and of lower weight, as compared to brush and commutator motors. Furthermore, the present exemplary BLDC motors are sensorless, which use back electromotive force (“BEMF”) speed of a rotor, via the associated microcontroller, a digital signal processor and a dedicated driver integrated circuit.

The exemplary sensorless motors are synergistically beneficial for the present automotive parking brake system. For example, the BEMF sensorless and brushless electric motors beneficially avoid potential failures and additional cost of adding components.

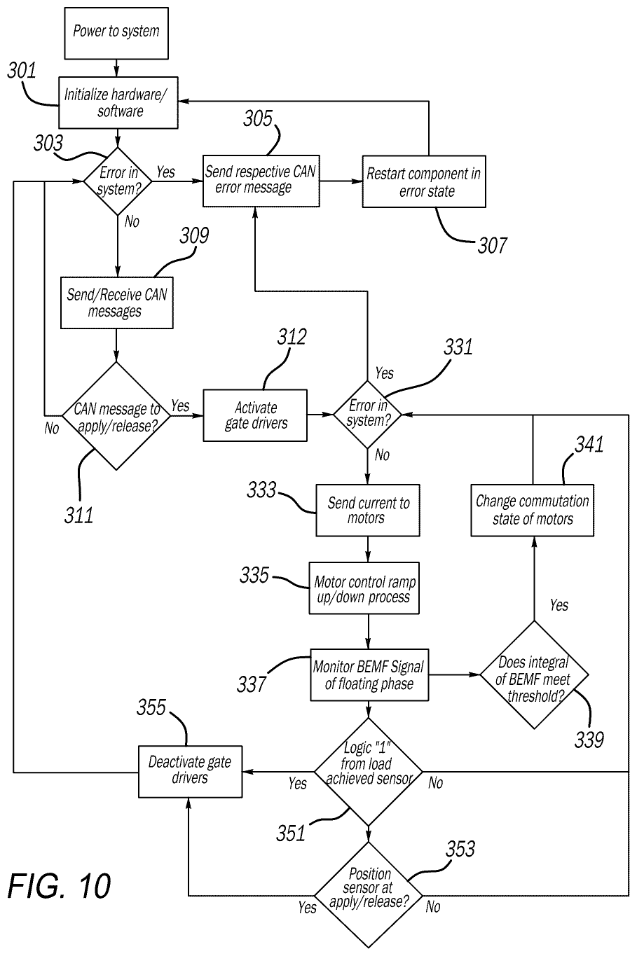

FIG. 10 illustrates an exemplary and non-limiting software logic flow diagram used with the present parking brake actuator apparatus. Programmed software instructions and steps stored in the non-transient memory and run by either or both of the microprocessor controller(s) on the circuit board, are configured to automatically operate as follows. Box 301 shows instructions initializing the hardware and software including the electronic components on the PCB and motor control circuitry. Box 303 detects and determines if there is an error in the electrical system. Box 305 sends a Controller Area Network (“CAN”) error message to the vehicle CAN Bus, specific to the component and/or function, if an error is detected. Box 307 restarts the electrical component in an error state, and boxes 303, 305 and 307 continue to function in an ongoing loop.

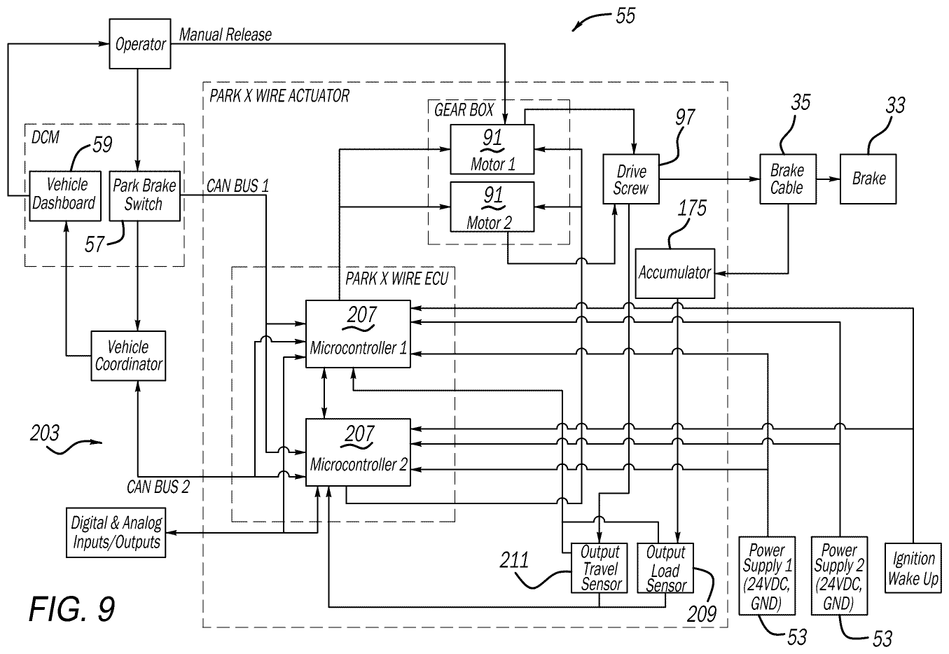

Box 309 acts to send and receive CAN messages, as regulated by the microprocessor(s) on the PCB, if there is no error detected, box 311 determines if the CAN message is to apply or release the cable, and box 312 activates motor gate drivers if there is a CAN message. This CAN message may be due to manual activation of the user-switch 57 (see FIGS. 1 and 9), automatically applying the cable due to a door 313 (see FIG. 1) being opened on a passenger bus vehicle or truck vehicle, automatically applying the cable due a wheel chair ramp being deployed on a passenger bus vehicle, automatically applying the cable due deployment of a moveable cargo lift 315 (see FIG. 1) adjacent to a cargo box of the truck vehicle, or the like.

Next, box 331 again detects and determines if there is an error in the electrical system, and if not, the software instructions proceed with the closed loop motor control steps of boxes 333, 335 and 337. At box 339, the microprocessor controller(s) determine if an integral of BEMF meets the desired and prestored threshold value or range of values; for example, comparing the voltage sensed at a floating phase of the brushless motor(s) at a given time (with no current from the PCT), to a threshold value (minimum and/or maximum). When the threshold value is reached (“yes”) then the microprocessor controller(s) change the commutation state of the motors by rotating the magnetic field of the motor(s) to apply torque, at box 341.

Furthermore, boxes 351 and 353 represent microprocessor controller determinations of whether the load-achieved sensor 209 (see FIGS. 6 and 9) for box 351 and travel/position sensor 211 for box 353 reach a desired and prestored minimum and/or maximum value(s) or range of values. If yes, gate drivers are deactivated at box 355, and if not, an error is determined at box 331.

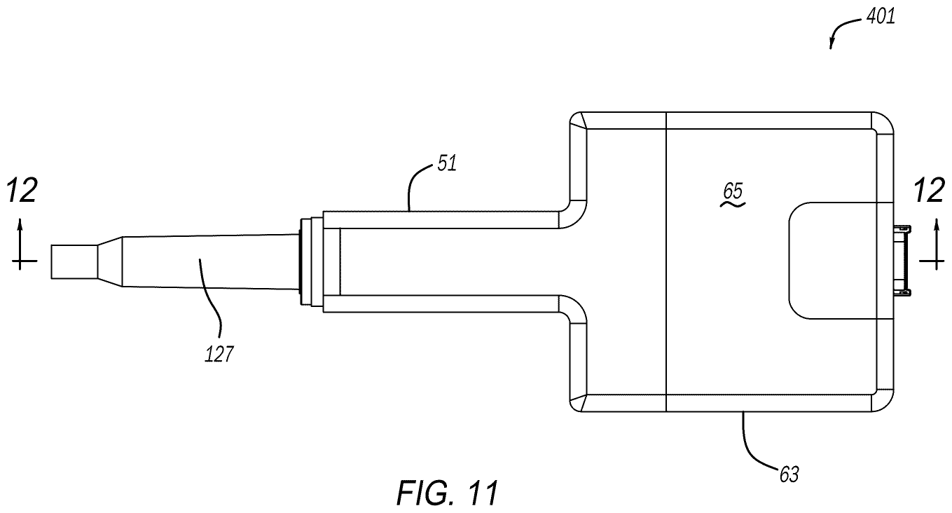

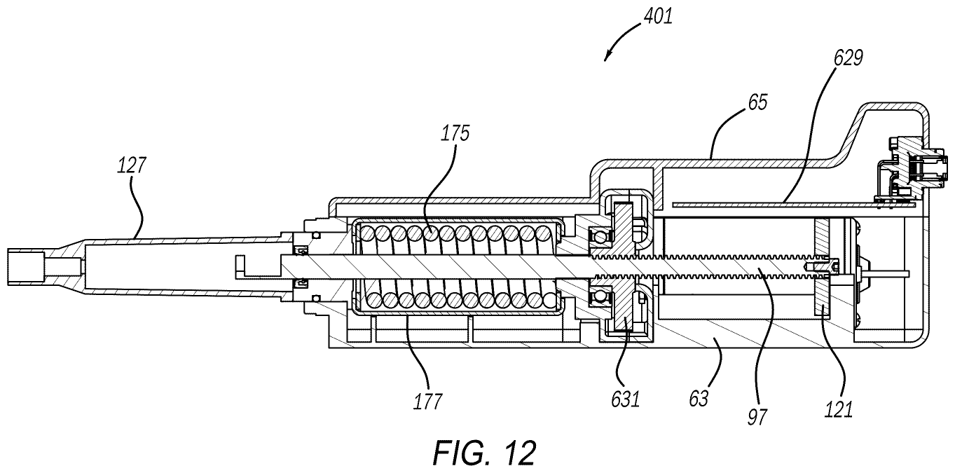

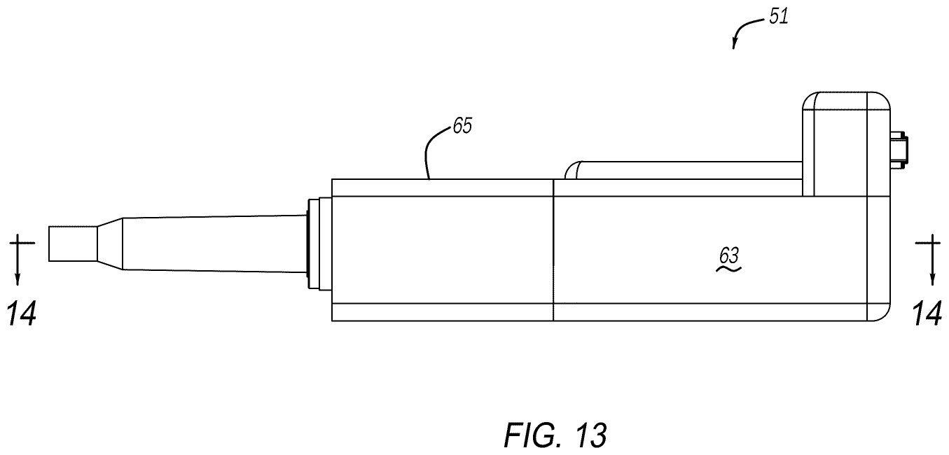

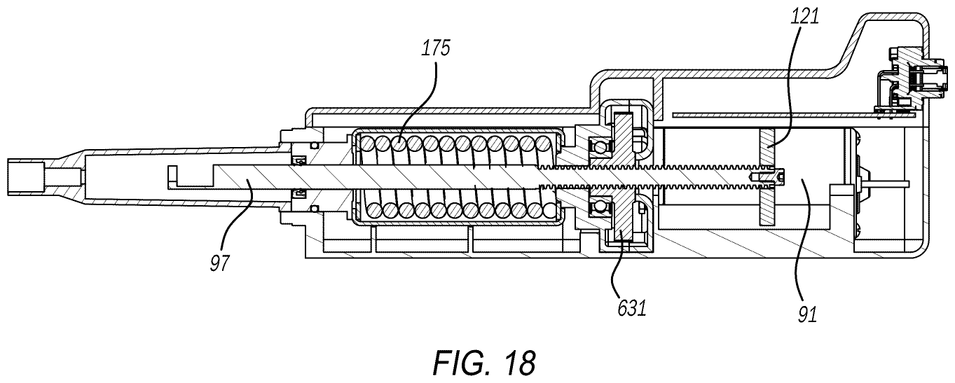

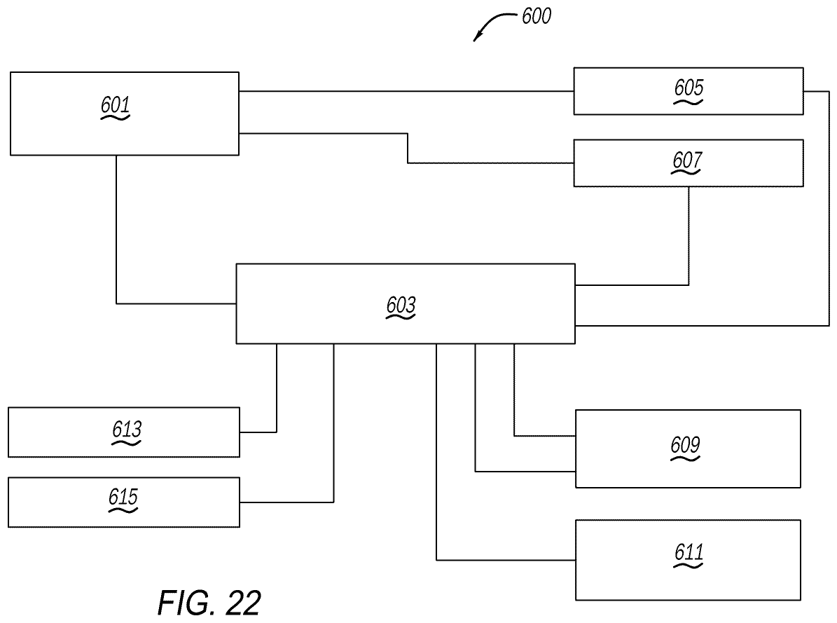

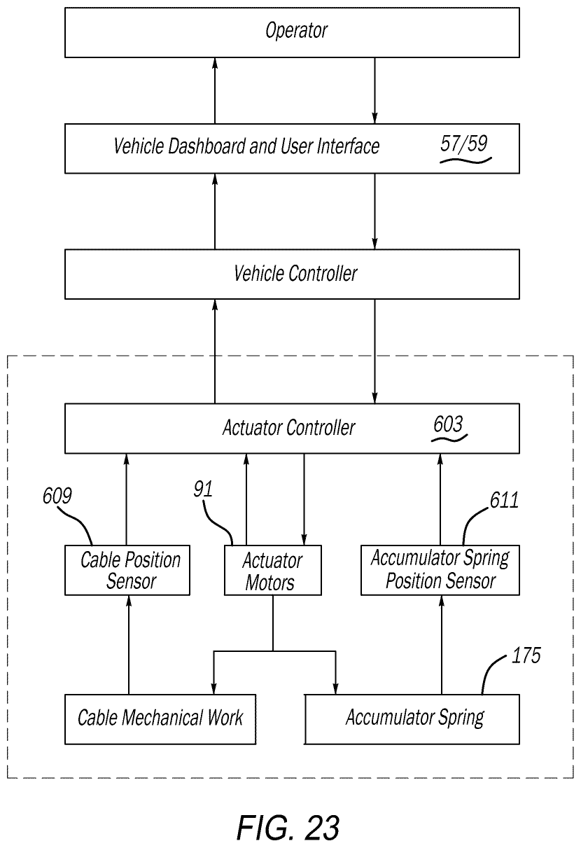

A second embodiment of the present parking brake actuator 401 is shown in FIGS. 11-21. Parking brake cable 35, housing 63 and 65, electric motor actuators 91, jackscrew shaft 97, pinion gears 117 and accumulator spring 175 are essentially the same as in the first embodiment. However, the electrical circuits 600 (see FIGS. 22 and 23) on printed circuit board 629 are slightly different. Also, the interaction of a main drive gear 631 to shaft 97, and to accumulator spring 175 differ.

A gear case within actuator assembly 401 includes drive gear 631 with an integral internally threaded nut portion (as illustrated) or a separately attached nut, which enmeshes with the drive screw portion of shaft 97. Pinion gear 117, operably rotated by each motor armature, serves to rotate the drive gear.

Laterally enlarged button or head 141 of cable 35 is removably received within a cavity behind undercut and inwardly turned flanges 145 at a distal end of the shaft. Accordingly, the shaft attaches to the brake cable to pull a mechanical brake, when either or both of the motors are energized. An O-ring shaft seal 641 is located between an outer surface of shaft 97 where it enters through a hollow piston or cap 643, and allows the shaft to slide therethrough. Also, a piston seal 645 is located between an outer surface of the piston or cap, and an open neck of the housing. It is noteworthy that the connection of the cable to the shaft occurs external to the sealed housing body 63 and housing cover 65. This beneficially allows removal and replacement of the cable without exposing the motors, gears and electronics to the normal dirty vehicle environment during repairs and maintenance.

A load sensor 647 is located within the housing between can 177 and a gear case 649. The load sensor detects movement from the accumulator can. The load sensor is electrically connected to an electrical circuit on a printed circuit board/electronic control unit. Furthermore, a travel sensor is integrated into printed circuit board assembly (“PCBA”) 629 and connected to the electrical circuit. The travel sensor detects a travel distance of block 121, affixed to the shaft, during cable pulling. The sensors may be Hall effect, inductive or other types of sensors. The output signals from the sensors are received by a programmable microprocessor controller, which runs software instructions stored in RAM or ROM memory attached to the circuit board.

Redundant electrical circuits, electronic components and battery power supplies are employed, one set for each electric motor. If a controller detects that one of the electric motors is not operating correctly or at all, whether due to a motor malfunction, electrical circuit/component malfunction, or power supply failure, it will automatically send an output signal to a warning indicator, such as a computer display screen, a warning LED light, an audio sound, and/or a remotely located controller. This will also reset hardware to attempt to continue operation, if possible. However, the system will not continue operation if safe operation is not possible, as automatically determined by the controller. Also, if a controller detects that the load sensor output has not exceeded a predetermined threshold value and/or the travel sensor has not sent a desired output signal despite motor energization, the controller will automatically send an output signal to a warning indicator.

The programmable controller and its software include the following steps (taken in any order, or simultaneously, with additional or fewer instructions being optionally employed):
(a) first instructions automatically energizing both of the electric motors;
(b) second instructions automatically sensing if both of the electric motors are functioning as desired;
(c) third instructions using back electromotive force voltage of a floating phase of the electric motors as an input to a closed loop system in order to control target speed of the electric motors and to control current to the electric motors;
(d) fourth instructions being configured to isolate a fault in at least one of: the first electric motor, the second electric motor or a gate driver, and continuing to operate using another of the electric motors or gate driver;
(e) fifth instructions being configured to turn off one of the electric motors when a fault is detected, while still maintaining braking force using the remaining of the electric motors;
(f) sixth instructions determining a braking state of the system by using signals from both a linear position sensor and a load-achieved sensor;
(g) seventh instructions checking whether a brake apply or release command was completed successfully based on feedback from at least one of the sensors;
(h) eighth instructions being configured to detect a fault by comparing an expected relationship between an actuator position and an applied load with measured values from the linear position and load-achieved sensors;
(i) ninth instructions being configured to detect a fault when the measured sensor values are at least one of: outside of a desired range, inconsistent, or do not change during a commanded actuator movement;
(j) tenth instructions being configured to identify whether the detected fault comes from the electric motors, the gate driver, the sensors, or controller area network communications buses;
(k) eleventh instructions being configured to stop further motor operation when the detected fault: continues longer than an allowed time or exceeds a defined limit; and
(l) twelfth instructions sending and receiving messages over two of the controller area network communications buses.

In summary, the present apparatus contains two electric motors utilizing two independent power sources. The actuator can accept two input signals to apply in case of a failure on the vehicle. Furthermore, the apparatus will detect cable load and cable travel. Doing this will allow detection of problems in the park brake system.

The actuator includes the load accumulator 175. The movement of the accumulator or accumulator spring facilitates detecting brake cable load. Furthermore, the accumulator also maintains adequate load on the brake if the brake travel changes after the motors are unpowered. This accumulator does this without requiring the brake to be overloaded to maintain adequate load. Some brakes require additional brake cable travel because of thermal changes after being applied. Some brakes require additional travel in the parking brake when the service brake is released.

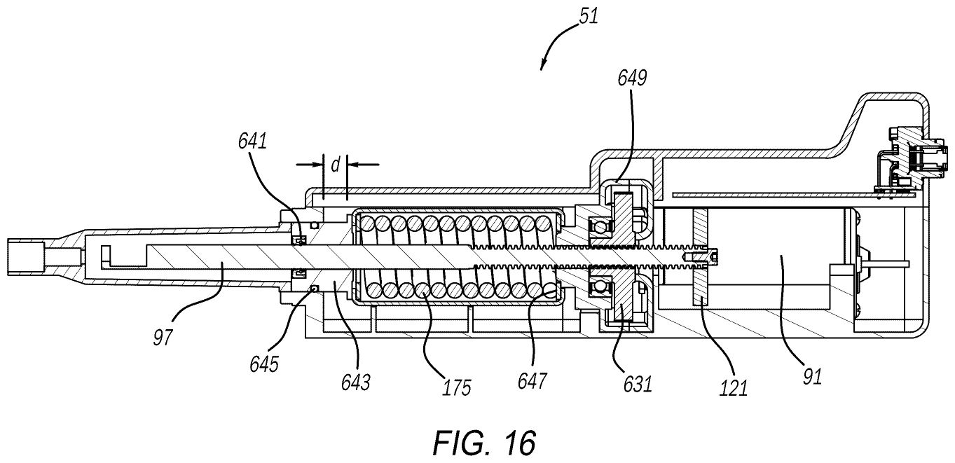

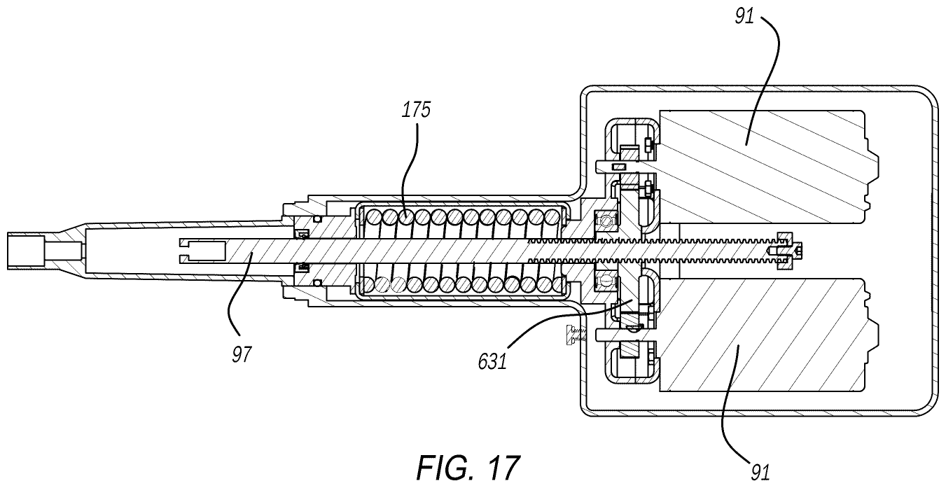

The brake-off position is illustrated in FIGS. 15, 16 and 20, while the brake-applied position can be observed in FIGS. 17-19. A comparison of these figures demonstrates the movement distance ‘c’ at one end (see FIG. 15) and ‘d’ at the opposite end (see FIG. 16) of accumulator spring 175, can 177 and piston 643, and the different positioning of shaft 97 and attached antirotational block 121, between these pulling and releasing parking brake actuator conditions. In the present configuration, when the spring is compressed, a fitting where the cable conduit attaches must slide into the housing. This motion of the conduit attachment fitting requires an additional sliding seal 645. Unlike in the first embodiment, the present second embodiment detects motion of components that are further away from the main circuit board, thereby employing additional electrical components such as an electrical cable and cable connectors as well as a secondary circuit board for detecting motion.

Referring to FIGS. 22 and 23, the present exemplary electrical circuit 600 includes a power management integrated circuit (“PMIC”) 601, a motor control unit (“MCU”) 603, gate drivers A and B 605 and 607, respectively, position sensor 609, load sensor 611, CAN transceiver A and B, 613 and 615, respectively. The signals passing through the circuit lines are described in the following Table 1.

TABLE 1

| Line | | |
|---|---|---|
| No | From → To | Signal Description |
| 1 | PMIC → Gate Driver A | Safety Enable Signal 1 (SS1) |
| 2 | PMIC → Gate Driver B | Safety Enable Signal 2 (SS2) |
| 3 | MCU ↔ PMIC | PMIC monitors MCU status signal |
| 4 | MCU ↔ Gate Driver A | Motor Control A (PWM/SPI Fault) |
| 5 | MCU ↔ Gate Driver B | Motor Control B (PWM/SPI/Fault) |
| 6 | CAN A ↔ MCU | CAN Bus A (Primary Vehicle Network) |
| 7 | CAN B ↔ MCU | CAN Bus B (Backup Vehicle Network) |
| 8 | Position Sensor → MCU | Position Feedback Analog |
| 9 | Position Sensor → MCU | Position Feedback PWM |
| 10 | Load Sensor → MCU | Load-Achieved Feedback |

Variations of the present apparatus include at least the following constructions. The first and/or second embodiment structural arrangement and function of the sensor(s), accumulator spring, piston, electrical circuitry and software instructions/steps, may alternately be employed with a single electric motor driving the main drive gear and/or jackscrew shaft, rather than the presently preferred redundant dual motor configuration. The unique present feature of movement of the accumulator spring providing an indication of achieving desired load or force, as sensed by a sensor and determined software instructions run by a programmable controller, may alternately be employed with a single electric motor driving the main drive gear, rather than the presently preferred redundant dual motor configuration. Also, the packaging of all of the sensors and/or electronics on a single circuit board located on the opposite side of a lateral plane defined by the main drive gear from the cable and/or accumulator spring, may be used with a single electric motor driving the main drive gear and/or jackscrew shaft, rather than the presently preferred redundant dual motor configuration. It is further envisioned that the first embodiment use of a linearly and longitudinally movable splined nut due to main drive gear rotation, to compress an accumulator spring, can alternately be employed with a single electric motor driving the main drive gear, rather than the presently preferred redundant dual motor configuration.

While various embodiments have been disclosed, it should be appreciated that other variations may be employed. For example, different gear types, quantities and positioning may be employed within the housing, although certain advantages may not be obtained. Moreover, the preferred accumulator spring may be replaced by multiple springs and/or in different positions, but certain benefits may not be realized. In another example, different electronic components and electrical circuits can be used, although some of the present features may not be obtained. While various embodiments of the present apparatus have been disclosed, modifications thereof are not to be regarded as a departure from the spirit or the scope of the present invention.

The invention claimed is:

1. An electric park brake apparatus comprising:
a housing;
a first electric motor located within the housing;
a second electric motor located within the housing, the motors being spaced apart from each other;
a shaft at least partially located within the housing, the shaft being longitudinally moved in response to energization of either of the electric motors;
a flexible brake cable coupled to the shaft being configured to cause vehicle brake engagement when either of the electric motors pulls the shaft.

2. The apparatus of claim 1, further comprising:
an anti-rotation block being coupled to the shaft and longitudinally sliding within a track located in the housing;
a main drive gear concentrically surrounding a portion of the shaft such that rotation of the main drive gear causes the shaft to longitudinally advance and retract due to the anti-rotation block; and
both of the first electric motor and the second electric motor simultaneously causing rotation of the main drive gear when the electric motors are energized and in a normal operating condition.

3. The apparatus of claim 2, further comprising:
a first pinion gear coupled to and rotating with an armature of the first electric motor;
a second pinion gear coupled to and rotating with an armature of the second electric motor;
the first pinion gear and the second pinion gear enmeshing with teeth on substantially opposite sides of the main gear; and
the shaft being located between the first electric motor and the second electric motor.

4. The apparatus of claim 1, further comprising:
an anti-rotation block being coupled to the shaft and longitudinally sliding within a track located in the housing;
a main drive gear concentrically surrounding a portion of the shaft such that rotation of the main drive gear causes the shaft to longitudinally advance and retract due to the anti-rotation block; and
wherein the first electric motor is configured to cause rotation of the main drive gear when energized, while the second electric motor is passive and configured to be deenergized when in an abnormal operating condition.

5. The apparatus of claim 1, wherein rotational axes of the first electric motor and of the second electric motor are parallel to each other, and parallel to a longitudinal centerline of the shaft.

6. The apparatus of claim 1, further comprising:
a spline nut having internal threads enmeshed with the shaft;
a main drive gear concentrically surrounding the spline nut such that rotation of the main drive gear causes the spline nut and the shaft to longitudinally advance and retract;
an accumulator piston surrounding a section of the shaft and being longitudinally movable with the spline nut; and
a compression spring biasing the accumulator piston toward the main drive gear.

7. The apparatus of claim 1, further comprising:
a main drive gear concentrically surrounding a portion of the shaft such that rotation of the main drive gear causes the shaft to longitudinally advance and retract;
an accumulator piston surrounding a section of the shaft and being longitudinally movable;
a compression spring biasing the accumulator piston toward the main drive gear; and
the first electric motor, the second electric motor, a threaded section of the shaft, the accumulator piston and the spring are all located within the housing.

8. The apparatus of claim 1, further comprising:
a seal compressing again a side of the shaft adjacent an end of the housing;
a tube fitting removably coupled to the end of the housing; and
a flexible parking brake cable including a laterally enlarged head removably coupled within a cavity behind an inwardly turned flange at an end of the shaft, the end of the shaft with the flange being longitudinally outboard of the housing and internal to the tube fitting.

9. The apparatus of claim 1, further comprising:
a first electrical circuit including a first position sensor and a first programmable controller, the first electrical circuit being connected to the first electric motor;
a second electrical circuit including a second position sensor and a second programmable controller, the second electrical circuit being connected to the second electric motor;
at least one of the programmable controllers synchronizing rotation of the first electric motor and the second electric motor; and
a section of the shaft being located between the first electric motor and the second electric motor.

10. The apparatus of claim 1, further comprising:
a main gear driven by both of the first electric motor and the second electric motor, the main gear being concentric with and operably causing rotation of the shaft;
an accumulator spring surrounding a portion of the shaft; and
a printed circuit board and a travel sensor projecting therefrom being located within the housing on a side of a main gear opposite the accumulator spring, the travel sensor being configured to detect longitudinal movement associated with the shaft.

11. The apparatus of claim 1, further comprising a sensor and a programmable controller connected to the sensor and the electric motors, the programmable controller operating software instructions, stored on non-transient memory, comprising:
(a) first instructions automatically energizing both of the electric motors;
(b) second instructions automatically sensing if both of the electric motors are functioning as desired;
(c) third instructions using back electromotive force voltage of a floating phase of the electric motors as an input to a closed loop system in order to control target speed of the electric motors and to control current to the electric motors;
(d) fourth instructions being configured to isolate a fault in at least one of: the first electric motor, the second electric motor or a gate driver, and continuing to operate using another of the electric motors or gate driver;
(e) fifth instructions being configured to turn off one of the electric motors when a fault is detected, while still maintaining braking force using the remaining of the electric motors;
(f) sixth instructions determining a braking state of the system by using signals from both a linear position sensor and a load-achieved sensor;
(g) seventh instructions checking whether a brake apply or release command was completed successfully based on feedback from at least one of the sensors;
(h) eighth instructions being configured to detect a fault by comparing an expected relationship between an actuator position and an applied load with measured values from the linear position and load-achieved sensors;
(i) ninth instructions being configured to detect a fault when the measured sensor values are at least one of: outside of a desired range, inconsistent, or do not change during a commanded actuator movement;
(j) tenth instructions being configured to identify whether the detected fault comes from the electric motors, the gate driver, the sensors, or controller area network communications buses;
(k) eleventh instructions being configured to stop further motor operation when the detected fault: continues longer than an allowed time or exceeds a defined limit; and
(l) twelfth instructions sending and receiving messages over two of the controller area network communications buses.

12. The apparatus of claim 1, further comprising a controller configured to automatically control the electric motors, which are sensor-less and brushless, by using back electromagnetic force on a floating phase of each of the electric motors to create an input for a closed loop motor control system, and by integrating the back electromagnetic force and comparing an integrated value to a desired threshold value set to determine when to commutate each of the electric motors.

13. The apparatus of claim 1, further comprising a programmable controller configured to automatically energize and deenergize the electric motors to pull and release a parking brake cable, and the programmable controller being configured to maintain pulling load on the parking brake cable when a door or a lift of a wheeled vehicle is in an open orientation.

14. The apparatus of claim 1, further comprising:
a first electrical circuit connected to the first electric motor;
a first battery configured to supply electricity to the first electrical circuit;
a second electrical circuit connected to the second electric motor;
a second battery configured to supply electricity to the second electrical circuit; and
at least one programmable controller configured to determine if there is a malfunction error in at least one of: the electric motors, the circuits or the batteries, and automatically sending an error output signal to a user-warning display when the error is detected.

15. The apparatus of claim 1, wherein:
(a) a nut is operably rotated by the main drive gear;
(b) before a preload force of the cable on a spring is exceeded, the nut operably longitudinally moves the shaft toward a brake-applied position;
(c) next, after the spring preload force is exceeded, further rotation of the nut operably causes the nut to longitudinally slide toward the spring which pushes a piston against the spring, while the shaft remains in substantially the same longitudinal position;
(d) when a travel sensor senses longitudinal positioning of the spline nut toward the spring, the travel sensor sends a signal to a microprocessor which then stops the electric motors, a full positioning of the nut toward the spring indicating that the spring preload force has been exceeded by a desired amount; and
(e) the preload force on the spring taking up travel in the cable while the motors remain stopped.

16. The apparatus of claim 1, further comprising a load-achieved sensor being configured to automatically detect movement of a preloaded spring via positioning of a piston or a splined nut, which is configured to indicate that a desired pulling load or force has been achieved on the parking brake cable.

17. An electric park brake apparatus comprising:
multiple electric motors;
a jackscrew shaft;
an anti-rotation block coupled to the shaft and being longitudinally slidable;
a drive gear concentrically surrounding a portion of the shaft such that rotation of the main gear causes the shaft to longitudinally advance and retract due to the anti-rotation block;
the electric motors simultaneously causing rotation of the main gear when the electric motors are energized and in a normal operating condition;
a first electrical circuit connected to one of the electric motors;
a first battery configured to supply electricity to the first electrical circuit;
a second electrical circuit connected to another of the electric motors;
a second battery configured to supply electricity to the second electrical circuit; and
at least one programmable controller configured to determine if there is a malfunction error in at least one of: the electric motors, the circuits or the batteries, and automatically sending an error output signal to a user-warning display when the error is detected; and
a brake cable coupled to the shaft being configured to cause vehicle brake engagement when the shaft is pulled.

18. The apparatus of claim 17, wherein rotational axes of the electric motors are parallel to each other, and parallel to a longitudinal centerline of the shaft.

19. The apparatus of claim 17, further comprising:
a spline nut having internal threads enmeshed with the shaft;
the drive gear concentrically surrounding the spline nut such that rotation of the drive gear causes the spline nut and the shaft to longitudinally advance and retract;
an accumulator piston surrounding a section of the shaft and being longitudinally movable with the spline nut; and
a compression spring biasing the accumulator piston toward the drive gear.

20. The apparatus of claim 17, further comprising:
a programmable controller connected to at least one of the electrical circuits being configured to automatically control the electric motors;
the electric motors being sensor-less and brushless; and
a sensor connected to at least one of the circuits being configured to detect a value associated with pulling load on the parking brake cable.

21. The apparatus of claim 17, wherein:
(a) a nut is operably rotated by the drive gear;
(b) before a preload force of the cable on a spring is exceeded, the nut operably longitudinally moves the shaft to away from the spring;
(c) next, after the spring preload force is exceeded, further rotation of the nut operably causes the nut to longitudinally slide toward the spring which pushes a piston against the spring, while the shaft remains in the same longitudinal position;
(d) when a travel sensor senses longitudinal positioning of the spline nut toward the spring, the travel sensor sends a signal to a microprocessor which then stops the electric motors, a full positioning of the nut toward the spring indicating that the spring preload force has been exceeded by a desired amount; and
(e) the preload force on the spring compensating for travel in the cable while the motors remain stopped.

22. The apparatus of claim 17, further comprising a load-achieved sensor being configured to automatically detect movement of a preloaded spring via positioning of a piston or a splined nut, which is configured to indicate that a desired pulling load or force has been achieved on the parking brake cable.

23. An electric park brake apparatus comprising:
an electric motor;
a jackscrew shaft;
an anti-rotation block coupled to the shaft and being longitudinally slidable;
a drive gear concentrically surrounding a portion of the shaft and including internally projecting splines, the electric motor being configured to rotate the drive gear;
a spline nut including externally projecting splines that enmesh with the splines of the drive gear, the spline nut further including internal threads enmeshed with the shaft;
rotation of the drive gear operably causing the spline nut and the shaft to rotate which simultaneously longitudinally advances and retracts the shaft due to the anti-rotation block;
at least one of: a spring and a parking brake cable pulling load, being configured to longitudinally bias the spline nut in a longitudinally direction; and
a sensor being configured to detect a longitudinal position of the spline nut.

24. The apparatus of claim 23, further comprising a second electric motor coupled to the drive gear, with rotational axes of the electric motors being parallel to each other and parallel to a longitudinal centerline of the shaft and the spline nut.

25. The apparatus of claim 23, further comprising a parking brake cable having a laterally enlarged head removably coupled within a flange of the shaft external to a sealed housing containing the motor, the drive gear and the spline nut, the parking brake cable being configured to cause vehicle brake engagement when the shaft is pulled.

26. The apparatus of claim 23, further comprising:
a programmable controller being configured to automatically control the electric motor;
the electric motor being sensor-less and brushless; and
the sensor connected being configured to detect a value associated with the pulling load.

27. The apparatus of claim 23, further comprising:
a piston longitudinally moving the spline nut;
the spring being a compression spring helically surrounding a section of the shaft;
the spring biasing the piston toward the spline nut and toward a lateral plane through the drive gear; and
the spline nut being longitudinally moveable relative to the shaft.

28. The apparatus of claim 23, wherein:
(a) before a preload force of the cable on the spring is exceeded, the spline nut operably longitudinally moves the shaft to away from the spring;
(b) next, after the spring preload force is exceeded, further rotation of the spline nut operably causes the spline nut to longitudinally slide toward the spring which pushes the piston against the spring, while the shaft remains in the same longitudinal position;
(c) when the sensor senses longitudinal positioning of the spline nut toward the spring, the sensor sends a signal to a controller which then stops the electric motor, a full positioning of the spline nut toward the spring indicating that the spring preload force has been exceeded by a desired amount; and
(d) the preload force on the spring compensating for travel in the cable while the motor remains stopped.

29. The apparatus of claim 23, wherein the sensor is configured to automatically detect movement of the spring via positioning of the piston or the spline nut, which is configured to indicate that a desired pulling load or force has been achieved on a vehicular parking brake cable.

30. A method of operating a parking brake actuator comprising:
(a) energizing at least one electric motor;
(b) rotating a drive gear by the electric motor;
(c) rotating a nut by the drive gear, the nut including externally projecting splines and an internal thread;
(d) longitudinally moving a jackscrew by rotation of the nut enmeshed therewith;
(e) pulling a parking brake cable with the jackscrew;
(f) biasing the nut away from a cable-engaging end of the jackscrew by a spring;
(g) before a preload force of the cable on a spring is exceeded, the nut longitudinally moving the jackscrew away from the spring;
(h) after the spring preload force is exceeded, further rotation of the nut longitudinally sliding the nut toward the spring;
(i) sensing longitudinal positioning of the nut and sending a signal to a programmable controller which then stops the electric motor, positioning of the nut toward the spring indicating that the spring preload force has been exceeded; and
(j) the preload force on the spring compensating for travel in the cable while the motor remains stopped.

31. A method of operating a parking brake actuator comprising:
(a) energizing multiple electric motors when a user-operated parking brake switch is activated, each of the electric motors including a rotor which rotates about a rotational axis, the rotational axes of the electric motors being substantially parallel to each other;
(b) rotating a drive gear by the rotors which are all coupled to the drive gear during rotation of the rotors; and
(c) longitudinally moving a jackscrew by rotation of the drive gear coupled thereto, a rotational axis of the jackscrew being substantially parallel to the axes of the rotors, and an end section of the jackscrew being configured to actuate a parking brake.

32. Programmable software for a parking brake actuator, stored in non-transient memory, the software comprising:
(a) instructions automatically energizing both of the electric motors;
(b) instructions automatically sensing if both of the electric motors are functioning as desired;
(c) instructions using back electromotive force voltage of a floating phase of the electric motors as an input to a closed loop system in order to control target speed of the electric motors and to control current to the electric motors;
(d) instructions being configured to isolate a fault in at least one of: the first electric motor, the second electric motor or a gate driver, and continuing to operate using another of the electric motors or gate driver;
(e) instructions being configured to turn off one of the electric motors when a fault is detected, while still maintaining braking force using the remaining of the electric motors;
(f) instructions determining a braking state of the system by using signals from both a linear position sensor and a load-achieved sensor;
(g) instructions checking whether a brake apply or release command was completed successfully based on feedback from at least one of the sensors;
(h) instructions being configured to detect a fault by comparing an expected relationship between an actuator position and an applied load with measured values from the linear position and load-achieved sensors;
(i) instructions being configured to detect a fault when the measured sensor values are at least one of: outside of a desired range, inconsistent, or do not change during a commanded actuator movement;
(j) instructions being configured to identify whether the detected fault comes from the electric motors, the gate driver, the sensors, or controller area network communications buses;
(k) instructions being configured to stop further motor operation when the detected fault: continues longer than an allowed time or exceeds a defined limit; and
(l) instructions sending and receiving messages over two of the controller area network communications buses.

33. The software of claim 32, further comprising instructions configured to determine if a vehicle door or lift is open and being configured to maintain pulling load on a parking brake cable when the open determination is make.
